(19) United States
(12) Patent Application Publication
(10) Pub. No.: US 2002/0124020 A1
(43) Pub. Date: Sep. 5, 2002

(54) Extracting textual equivalents of multimedia content stored in multimedia files

(75) Inventors: Janani Janakiraman, Austin, TX (US); Rabindranath Dutta, Austin, TX (US)

Correspondence Address: Kelly K. Kordzik, Suite 800, 100 Congress Avenue, Austin, TX, 78701, US

(73) Assignee: International Business Machines Corporation, Armonk, NY (US)

(21) Appl. No.: 09/798,061

(22) Filed: Mar. 1, 2001

(51) Int. Cl. G06F 17/27

(52) U.S. Cl. 707/513

(57) ABSTRACT

A method, system and computer program product for extracting textual equivalents of multimedia content stored in multimedia files. A file, e.g., HTML file, may be scanned for a multimedia file tag which may identify a multimedia file. Upon identifying a multimedia file, a determination may be made as to whether there is an attribute that provides textual equivalents for the multimedia content associated with the multimedia file identified. If there is not an attribute that provides textual equivalents for the multimedia content associated with the multimedia file, then one or more packets of data associated with the multimedia file identified may be scanned for one or more descriptor fields comprising textual equivalents for the multimedia content associated with the multimedia file. Upon identifying one or more descriptor fields, textual equivalents for the multimedia content associated with the multimedia file may be extracted and subsequently streamed to a web browser.

### CROSS REFERENCE TO RELATED APPLICATIONS

The present invention is related to the following U.S. patent applications which are hereby incorporated herein by reference:

Ser. No. 09/______ , “Apparatus To Convey Depth Information In Graphical Images And Method Therefor” (Attorney Docket No. AUS9-2001-0094US1);

Ser. No. 09/______ , “Apparatus For Outputting Textual Renditions Of Graphical Data And Method Therefor” (Attorney Docket No. AUS9-2001-0095US1); and

Ser. No. 09/______ , “Scanning and Outputting Textual Information in Web Page Images” (Attorney Docket No. AUS9-2001-0096US1).

### TECHNICAL FIELD

The present invention relates to the field of assisting individuals with disabilities through technology, and more particularly to extracting text equivalents of multimedia content stored in multimedia files that are used to produce web pages in order to promote accessibility to individuals with disabilities.

### BACKGROUND INFORMATION

Congress passed the “Assistive Technology Act of 1998” to promote the assistance of individuals with disabilities through technology such as encouraging the promotion of technology that will allow individuals with disabilities to partake in the information technology, e.g., Internet.

The development of computerized distribution information systems, such as the Internet, allows users to link with servers and networks, and thus retrieve vast amounts of electronic information that was previously unavailable using conventional electronic mediums. Such electronic information increasingly is replacing the more conventional means of information such as newspapers, magazines and television.

Users may be linked to the Internet through a hypertext system of servers commonly referred to as the World Wide Web (WWW). With the World Wide Web, an entity having a domain name may create a “web page” or “page” that can provide information and to a limited degree some interactivity.

A computer user may “browse”, i.e. navigate around, the WWW by utilizing a suitable web browser, e.g., Netscape Navigator™, Internet Explorer™, and a network gateway, e.g., Internet Service Provider (ISP). A web browser allows the user to specify or search for a web page on the WWW and subsequently retrieve and display web pages on the user's computer screen. Such web browsers are typically installed on personal computers or workstations to provide web client services, but increasingly may be found on wireless devices such as cell phones.

The Internet is based upon a suite of communication protocols known as Transmission Control Protocol/Internet Protocol (TCP/IP) which sends packets of data between a host machine, e.g., server computer on the Internet commonly referred to as web server, and a client machine, e.g., a user's computer connected to the Internet. The WWW is a network of computers that use an Internet interface protocol which is supported by the same TCP/IP transmission protocol.

A web page may typically include multimedia content, i.e. images, video and audio. Examples of visual images may include navigational menus, pop-up windows/menus, charts and graphs. Images, audio and video may be specified in a HyperText Mark-up Language (HTML) file that is sent from the web server to the client machine. In the HTML source code, images, video and audio may be specified in various files of different formats. For example, an image may be represented in a Graphics Interchange Format (GIF), Joint Photographic Experts Group (JPEG) and Portable Network Graphics (PNG) file format. Video may be represented in a Moving Pictures Expert Group (MPEG) file format. Audio may be represented in a MPEG Audio Layer 3 (MP3) file format. The HTML file may then be parsed by the web browser in order to display the images and graphics on the display as well as generate audio through the speakers on the client machine.

Unfortunately, individuals who are visually impaired may not be able to view the images on web pages. Furthermore, individuals who are hearing impaired may not be able to hear the audio information specified in the HTML file.

It would therefore be desirable to extract text equivalents of multimedia content stored in multimedia files that are used to produce web pages in order to promote accessibility to individuals with disabilities such as individuals who are visually impaired.

### SUMMARY

The problems outlined above may at least in part be solved in some embodiments by extracting textual equivalents for the multimedia content, e.g., images, audio, video, in packets of data associated with a multimedia file.

In one embodiment, a method for extracting textual equivalents in multimedia files comprises the step of receiving a file, e.g., HTML file, specifying one or more multimedia files. The received file, e.g., HTML file, may be scanned for a multimedia file tag which may identify a multimedia file. That is, the multimedia file tag may identify the file storing multimedia content, e.g., images, audio, video. Upon identifying a multimedia file tag, a determination may be made as to whether there is an attribute, e.g., ALT attribute, that provides textual equivalents for the multimedia content associated with the multimedia file associated with the multimedia tag identified. If there is an attribute that provides textual equivalents for the multimedia content associated with the multimedia file, then the attribute, i.e. textual equivalents for the multimedia content, may be streamed to a web browser. If there is not an attribute that provides textual equivalents for the multimedia content associated with the multimedia file, then one or more packets of data associated with the multimedia file identified may be scanned for one or more descriptor fields comprising textual equivalents for the multimedia content associated with the multimedia file. Upon identifying one or more descriptor fields, textual equivalents for the multimedia content associated with the multimedia file may be extracted and subsequently streamed to a web browser.

In another embodiment of the present invention, upon streaming the textual equivalents to the web browser, the web browser may be configured to output the textual equivalents of the multimedia content in the multimedia file to a Braille display and/or speech synthesizer and/or speaker and/or display. By outputting the textual equivalents of the multimedia content, e.g., audio, in the multimedia file identified to a display. a deaf person may be able to visually see the textual equivalent of audio information, e.g., song. By outputting the textual equivalents of the multimedia content, e.g., image, in the multimedia file identified to a speech synthesizer and/or speaker, a blind person may now be able to hear the textual equivalent of the image via the speech synthesizer and/or speaker. By outputting the textual equivalents of the multimedia content, e.g., image, in the multimedia file identified to a Braille display a blind person may now be able to read the textual equivalent of the image via the Braille display.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

A better understanding of the present invention can be obtained when the following detailed description is considered in conjunction with the following drawings, in which:

FIG. 1 illustrates a network system configured in accordance with the present invention;

FIG. 2 illustrates an embodiment of the present invention of a client in a network system;

FIG. 3 is a flowchart of a method for extracting textual equivalents in multimedia files;

FIG. 4 illustrates an embodiment of a packet of data associated with a multimedia file configured in accordance with the present invention;

FIG. 5 illustrates an ALT attribute that provides a textual equivalent for an image; and

FIG. 6 illustrates an embodiment of a packet of data associated with a GIF file configured in accordance with the present invention.

### DETAILED DESCRIPTION

The present invention comprises a method, system and computer program product for extracting textual equivalents of multimedia content stored in multimedia files. In one embodiment of the present invention, a method comprises the step receiving a file, e.g., HTML file, specifying one or more multimedia files. The received file, e.g., HTML file, may be scanned for a multimedia file tag which may identify a multimedia file. That is, the multimedia file tag may identify the file storing multimedia content, e.g., images, audio, video. Upon identifying a multimedia file, a determination may be made as to whether there is an attribute, e.g., ALT attribute, that provides textual equivalents for the multimedia content associated with the multimedia identified. If there is an attribute that provides textual equivalents for the multimedia content associated with the multimedia file, then the attribute, i.e. textual equivalents for the multimedia content, may be streamed to a web browser. If there is not an attribute that provides textual equivalents for the multimedia content associated with the multimedia file, then one or more packets of data associated with the multimedia file identified may be scanned for one or more descriptor fields comprising textual equivalents for the multimedia content associated with the multimedia file. Upon identifying one or more descriptor fields, textual equivalents for the multimedia content associated with the multimedia file may be extracted and subsequently streamed to a web browser. Upon streaming the textual equivalents to the web browser, the web browser may be configured to output the textual equivalents of the multimedia content in the multimedia file to a Braille display and/or speech synthesizer and/or speaker and/or display.

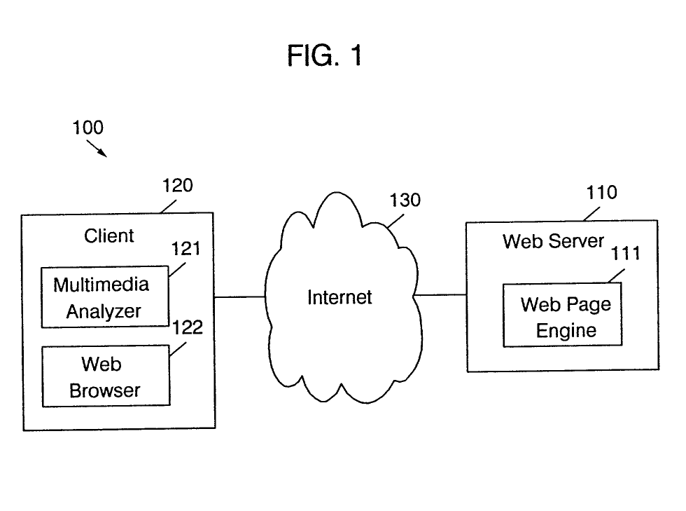

### FIG. 1—Network System

FIG. 1 illustrates an embodiment of the present invention of a network system 100. Network system 100 may comprise a web server 110 connected to a client 120 via the Internet 130. The Internet 130 may refer to a network of computers. It is noted that network system 100 may comprise a plurality of clients 120 connected to web server 110 via the Internet 130 and that FIG. 1 is illustrative.

Web server 110 may comprise a web page engine 111 for maintaining and providing access to an Internet web page which is enabled to forward a Hyper-Text Mark-up Language (HTML) file to a multimedia analyzer 121 of client 120. The HTML file may specify multimedia files, e.g., GIF, JPEG, PNG, MPEG, MP3, that comprise multimedia content. For example, images, e.g., graphical representations of texts (including symbols), image map regions, animation (e.g., animated GIFs), applets and programmatic objects, ASCII art, frames, scripts, images used as list bullets, spacers, graphical buttons, may be stored in a GIF, JPEG, PNG file format. Video may be stored in a MPEG file format. Audio, e.g., sounds (played with or without user interaction), stand-alone audio files, audio tracks of video, may be stored in a MP3 file format.

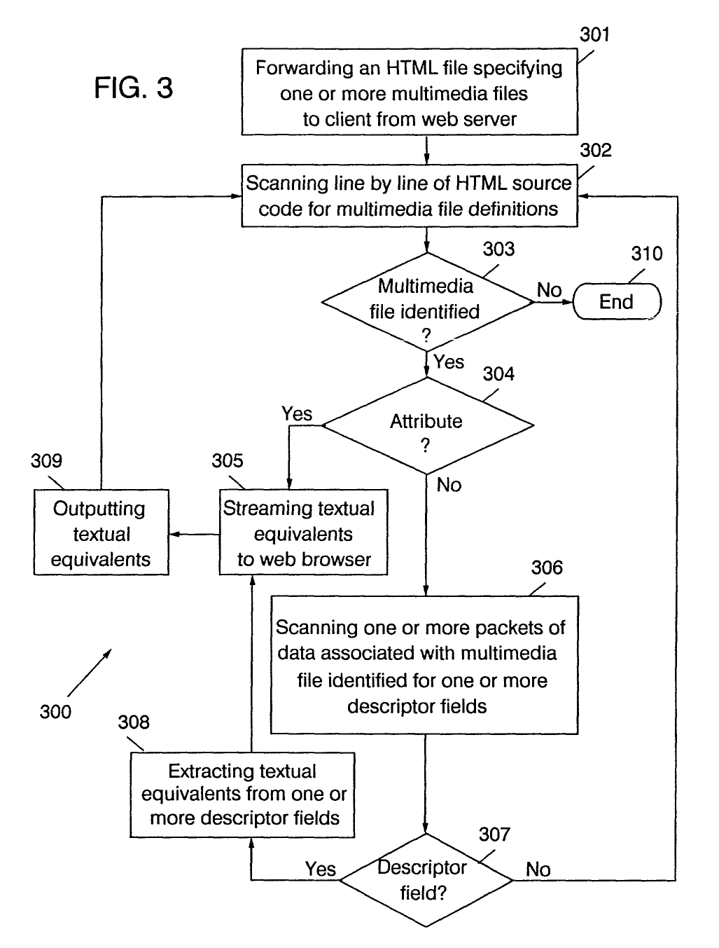

As stated above, the HTML file sent to multimedia analyzer 121 from web page engine 111 may specify multimedia files, e.g., GIF, JPEG, PNG, MPEG, MP3, that comprise multimedia content. Client 120 may comprise multimedia analyzer 121 configured to scan the packets of data associated with the specified multimedia files in the HTML file sent to multimedia analyzer 121 as discussed in greater detail in the description of FIG. 3. Upon scanning the packets of data associated with each multimedia file, multimedia analyzer 121 may construct textual equivalents for the multimedia content, e.g., image, video, audio, associated with the packets of data scanned if the multimedia file did not contain a textual equivalent for the multimedia content. Textual equivalents may refer to a textual description of the multimedia content, e.g., image, video, audio. For example, textual equivalents of an audio file may be the title as well as the words of the song. Upon constructing the textual equivalents for the multimedia content, e.g., image, video, audio, associated with the packets of data scanned, multimedia analyzer 121 may stream the constructed textual equivalents to a web browser 122. Web browser 122 may be configured for communicating with the Internet 130 and for reading and executing textual equivalents of multimedia content in web pages. While the illustrated client engine is a web browser 122, those skilled in the art will recognize that other client engines may be used in accordance with the present invention. In one embodiment, multimedia analyzer 121 may be a plug-in to web browser 122. In another embodiment, multimedia analyzer 121 may be directly incorporated as an option in web browser 122.

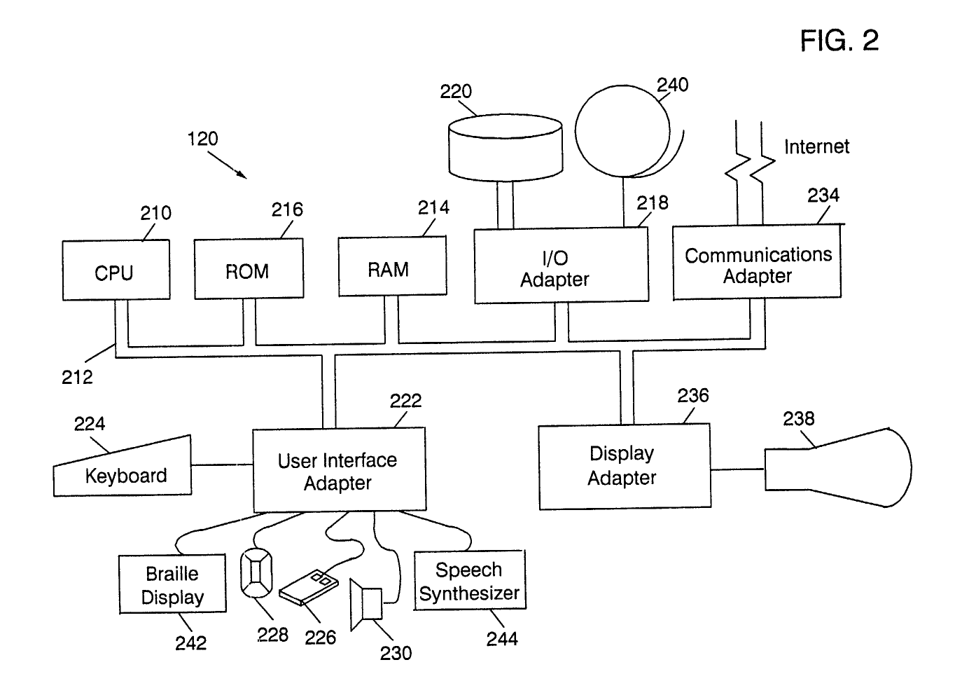

### FIG. 2—Hardware Configuration of Client

FIG. 2 illustrates a typical hardware configuration of client 120 which is representative of a hardware environment for practicing the present invention. Client 120 has a central processing unit (CPU) 210, such as a conventional microprocessor, coupled to various other components by system bus 212. An operating system 240, runs on CPU 210 and provides control and coordinates the function of the various components of FIG. 2. Application 260, e.g., web browser 122 with multimedia analyzer 121 as a plug-in to web browser 122, web browser 122 with multimedia analyzer 121 directly incorporated as an option in web browser 122, runs in conjunction with operating system 240 and provides output calls to operating system 240 which implements the various functions to be performed by the application 260. Read only memory (ROM) 216 is coupled to system bus 212 and includes a basic input/output system (“BIOS”) that controls certain basic functions of client 120. Random access memory (RAM) 214, I/O adapter 218, and communications adapter 234 are also coupled to system bus 212. It should be noted that software components including operating system 240 and application 260 are loaded into RAM 214 which is the computer system's main memory. I/O adapter 218 may be a small computer system interface (“SCSI”) adapter that communicates with disk units 220, e.g., disk drive, and tape drives 240. It is noted that the method for extracting text equivalents in multimedia files as described in FIG. 3 may be implemented by web browser 122 which may reside in application 260 or disk units 220. In one embodiment, multimedia analyzer 121 may be a plug-in to web browser 122. In another embodiment, multimedia analyzer 121 may be directly incorporated as an option in web browser 122. It is further noted that the method for extracting text equivalents in multimedia files as described in FIG. 3 may be implemented by multimedia analyzer 121 in conjunction with web browser 122 where both multimedia analyzer 121 and web browser 122 may reside in application 260 or disk units 220. Communications adapter 234 interconnects bus 212 with the Internet 130 enabling client 120 to communicate with the Internet 130. Input/Output devices are also connected to system bus 212 via a user interface adapter 222 and a display adapter 236. Keyboard 224, trackball 228, mouse 226, speaker 230, speech synthesizer 244 and Braille display 242 are all interconnected to bus 212 through user interface adapter 222. Event data may be input to client 120 through keyboard 224, trackball 228 and mouse 226. A display monitor 238 is connected to system bus 212 by display adapter 236. In this manner, a user is capable of inputting to client 120 through keyboard 224, trackball 228 or mouse 226 and receiving output from client 120 via display 238, speaker 230, speech synthesizer 244 and Braille display 242.

Preferred implementations of the invention include implementations as a computer system programmed to execute the method or methods described herein, and as a computer program product. According to the computer system implementations, sets of instructions for executing the method or methods are resident in the random access memory 214 of one or more computer systems configured generally as described above. Until required by client 120, the set of instructions may be stored as a computer program product in another computer memory, for example, in disk drive 220 (which may include a removable memory such as an optical disk or floppy disk for eventual use in disk drive 220). Furthermore, the computer program product can also be stored at another computer and transmitted when desired to the user's work station by a network or by an external network such as the Internet. One skilled in the art would appreciate that the physical storage of the sets of instructions physically changes the medium upon which it is stored so that the medium carries computer readable information. The change may be electrical, magnetic, chemical or some other physical change.

### FIG. 3—Method for Extracting Textual Equivalents in Multimedia Files

FIG. 3 illustrates a flowchart of one embodiment of the present invention of a method 300 for extracting textual equivalents in multimedia files. As stated in the Background Information section, images, audio and video may be specified in a Hyper-Text Mark-up Language (HTML) file that is sent from the web server to the client machine. In the HTML source code, images, video and audio may be specified in various files of different formats. For examples, an image may be represented in a GIF, JPEG, PNG file format. Video may be represented in a MPEG file format. Audio may be represented in a MP3 file format. The HTML file may then be parsed in order to display the images of the web page on the display as well as generate the audio on the web page through speakers of the client machine. Unfortunately, individuals who are visually impaired may not be able to view the images on web pages. Furthermore, individuals who are hearing impaired may not be able to hear the audio information specified in the HTML file. It would therefore be desirable to extract text equivalents of multimedia content stored in multimedia files that are used to produce web pages in order to promote accessibility to individuals with disabilities such as individuals who are visually impaired. Method 300 is a method for extracting textual equivalents in multimedia files, e.g., images, video, audio, that are used to produce web pages in order to promote accessibility to individuals with disabilities.

In step 301, web page engine 11 of web server 110 may be configured to forward an HTML file specifying one or more multimedia files to client 120 so that web browser 122 of client 120 may output textual equivalents of the multimedia content in the one or more multimedia files to display 238, Braille display 242, speech synthesizer 242 and speaker 230 of client 120. As stated above, images, e.g., graphical representations of texts (including symbols), image map regions, animation (e.g., animated GIFs), applets and programmatic objects, ASCII art, frames, scripts, images used as list bullets, spacers, graphical buttons, audio, e.g., sounds (played with or without user interaction), stand-alone audio files, audio tracks of video, and video may be stored in multimedia files in the HTML file forwarded to client 120. For example,

<IMG SRC=“warning.gif”>

in the HTML source code may indicate that the image SRC may found in the file warning.gif where “.gif” indicates that the image is stored in the file format of GIF.

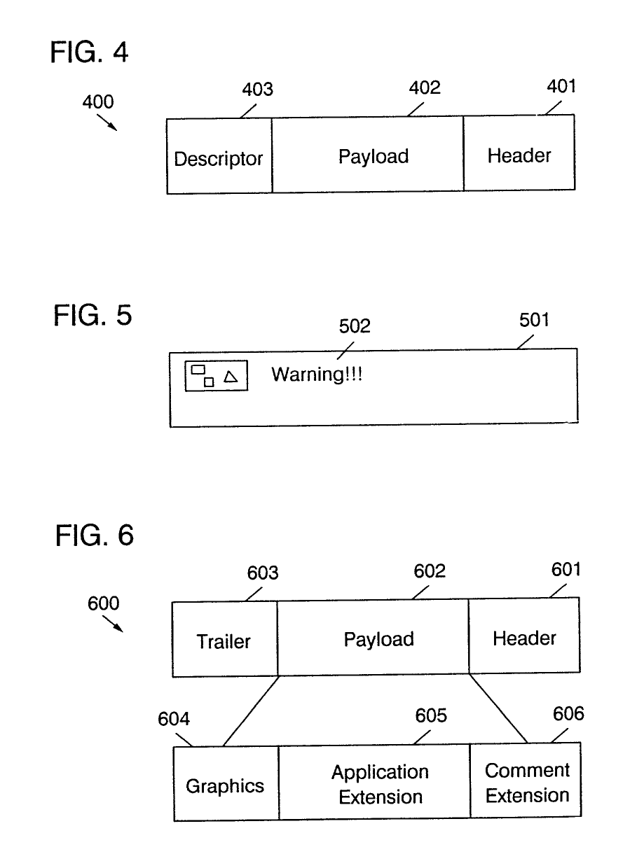

Each of the one or more multimedia files specified in the HTML file forwarded to client 120 may be represented by packets of data as illustrated in FIG. 4 FIG. 4 illustrates an embodiment of the present invention of a packet 400 of data where packet 400 may comprise a packet header field 401, a payload 402 and a descriptor field 403. Payload 402 may comprise packet data associated with a particular file that enables web browser 122 to generate multimedia content, e.g., images, video, audio, on a web page. Packet header field 401 may comprise information as to what format the packet data is written, e.g., GIF, JPEG, PNG, MPEG, MP3. Descriptor field 403 may comprise textual equivalents of the multimedia content associated with the packet data in payload 402. Textual equivalents may refer to a textual description of the multimedia content, e.g., image, video, audio. For example, textual equivalents of an audio file may be the title as well as the words of the song. In one embodiment, descriptor field 403 may be located in header 401. In another embodiment, descriptor field 403 may be located in payload 402. It is noted that not all packets of data 400 may comprise a descriptor field 403.

In step 302, multimedia analyzer 121 of client 120 scans the HTML source code line by line for a multimedia file, e.g., image, voice, audio, tag that identifies a particular multimedia file. For example,

<IMG SRC=“warning.gif”>

in the HRML source code is an image tag that may indicate that the image SRC may be found in the file warning.gif where “.gif” indicates that the image is stored in the file format of GIF.

In step 303, a determination is made as to whether a multimedia file tag was identified. If a multimedia file tag was not identified, then method 300 may be terminated in step 310.

In step 304, if a multimedia file tag was identified, a determination may be made as to whether there is an attribute, e.g., ALT attribute, LONGDESC attribute, that provides a textual equivalent for the multimedia content, e.g., image, audio, video, stored in the multimedia file identified in step 303. For example,

<IMG SRC=“warning.gif”ALT=“Warning!!!”>

in the HTML source code may indicate that there exists an attribute, e.g., ALT=“Warning!!!”, that provides the textual equivalent of “Warning!!!!” when images are turned off in browser 122. That is, in place of the image, there will appear the text “Warning!!!” in the place holder for the image as illustrated in FIG. 5. FIG. 5 illustrates that a tag 502, e.g., “Warning!!!”, may be placed in the place holder 501 for the image on the web page instead of the image when images are turned off in browser 122. A LONGDESC attribute may be used to specify a link to a long description of the image. For example,

<IMG SRC=“warning.gif”LONGDESC=“warningmap.html”>

in the HTML source code may indicate that there exists an attribute, e.g., LONGDESC attribute, that specifies a link. e.g., warningmap.html, to a textual description of the image stored in warning.gif. When images are turned off in browser 122, the textual description of the image stored in the link “warningmap.html” may appear in place of the image stored in warning.gif.

If multimedia analyzer 121 identified an attribute, e.g., ALT attribute, that provides a textual equivalent for the multimedia content, e.g., image, audio, video, stored in the multimedia file identified, then multimedia analyzer 121 may be configured to stream the attribute, e.g., ALT attribute, that provides a textual equivalent for the multimedia content, e.g., image, audio, video, in the multimedia file identified to web browser 122 in step 305.

If multimedia analyzer 121 did not identify an attribute, e.g., ALT attribute, associated with the multimedia content, e.g., image, audio, video, stored in the multimedia file identified in step 303, then multimedia analyzer 121 may be configured to scan one or more packets of data associated with the multimedia file, e.g., image, video, audio, identified in the HTML file for one or more descriptor fields in step 306. Referring to FIG. 4, packet 400 of data may comprise a packet header field 401, a payload 402 and a descriptor field 403. Descriptor field 403 may comprise textual equivalents for the multimedia content associated with the packet data in payload 402. It is noted that descriptor field 403 may be located in header 401 or in payload 402. For example, textual equivalents for the multimedia content may be stored in a descriptor field 403 commonly referred to as a comment extension field within the payload of a GIF packet of data as illustrated in FIG. 6. FIG. 6 illustrates an embodiment of a GIF packet 600 of data comprising a header field 601, a payload 602 and a trailer field 603. Header field 601 may comprise information as to what format the packet data is written, e.g., GIF. Trailer field 603 may comprise information indicating the end of packet 600. Payload 602 may comprise packet data associated with the particular GIF file that enables web browser 122 to generate multimedia content, e.g., images, on a web page. Payload 602 may comprise a graphic block 604, an application extension field 605 and a comment extension field 606. Graphic block 604 may comprise graphical data. Application extension field 605 may comprise application specific information. Comment extension field 606 may comprise textual information, e.g., comments, descriptions, for the content associated with the packet data in payload 602 in packet 600. It is noted that comment extension field 606 is an optional field in GIF packet 600.

In step 307, a determination may be made as to whether the one or more packets of data scanned in step 306 has a descriptor field 403 with textual equivalents of the multimedia content associated with the multimedia file identified in step 303. If one or more descriptor fields 403 with textual equivalents of the multimedia content associated with the multimedia file identified in step 303 has been identified, then multimedia analyzer 121 may be configured to extract the textual equivalents from the one or more descriptor fields 403 in step 308. As stated above, the textual equivalents in the one or more descriptor fields 403 may comprise the textual equivalents of the multimedia content, e.g., image, audio, video, associated with the packet data in payload 402.

Upon extracting the textual equivalents in the one or more descriptor fields 403, multimedia analyzer 121 may be configured to stream the textual equivalents for the multimedia file, e.g., image, audio, video, identified in step in step 303 to web browser 122 in step 305.

Referring to step 307, if a descriptor field with textual equivalents of the multimedia content, e.g., image, audio, video, associated with multimedia file identified in step 303 has not been identified, then multimedia analyzer 121 of client 120 scans the HTML source code line by line for the next multimedia file tags in step 302.

Referring to step 305, upon streaming the textual equivalents to web browser 122, web browser 122 may be configured to output the textual equivalents of the multimedia content in the multimedia file identified in step 303 to display 238 and/or Braille display 242 and/or speech synthesizer 244 and/or speaker 230 of client 120 in step 309. By outputting the textual equivalents of the multimedia content, e.g., audio, in the multimedia file identified in step 303 to display 238, a deaf person may be able to see the textual equivalent of audio information, e.g., song. By outputting the textual equivalents of the multimedia content, e.g., image, in the multimedia file identified in step 303 to speech synthesizer 244 and/or speaker 230, a blind person may now be able to hear the textual equivalent of the image via speech synthesizer 244 and/or speaker 230. By outputting the textual equivalents of the multimedia content, e.g., image, in the multimedia file identified in step 303 to Braille display 242 a blind person may now be able to read the textual equivalent of the image via Braille display 242.

Upon outputting the textual equivalents of the multimedia content in the multimedia file identified in step 303 to display 238 and/or Braille display 242 and/or speech synthesizer 244 and/or speaker 230 of client 120 in step 309, multimedia analyzer 121 of client 120 scans additional lines of code in the HTML source code line by line for a multimedia file, e.g., image, voice, audio, tag that identifies a particular multimedia file in step 302.

It is noted that the steps of method 300 may be implemented exclusively by web browser 122 which may reside in application 360 or disk units 320. In one embodiment, multimedia analyzer 121 may be a plug-in to web browser 122. In another embodiment, multimedia analyzer 121 may be directly incorporated as an option in web browser 122. It is further noted that the steps of method 300 may be implemented by multimedia analyzer 121 in conjunction with web browser 122 as stated above where both multimedia analyzer 121 and web browser 122 may reside in application 260 or disk units 220.

Although the system, computer program product and method are described in connection with several embodiments, it is not intended to be limited to the specific forms set forth herein, but on the contrary, it is intended to cover such alternatives, modifications, and equivalents, as can be reasonably included within the spirit and scope of the invention as defined by the appended claims. It is noted that the headings are used only for organizational purposes and not meant to limit the scope of the description or claims.

1. A method for extracting textual equivalents of multimedia content stored in multimedia files comprising the steps of:
receiving a file specifying one or more multimedia files;
scanning said file for a multimedia file tag;
scanning one or more packets of data associated with one of said one or more multimedia files associated with said multimedia file tag for one or more descriptor fields, wherein said one or more descriptor fields comprise textual equivalents of a multimedia content of said one of said one or more multimedia files; and
extracting said textual equivalents in said one or more descriptor fields.

2. The method as recited in claim 1 further comprising the step of:
determining whether said one of said one or more multimedia files has an attribute with said textual equivalents of said multimedia content of said one of said one or more multimedia files.

3. The method as recited in claim 2, wherein said attribute is an ALT attribute.

4. The method as recited in claim 2, wherein said attribute is a LONGDESC attribute.

5. The method as recited in claim 2, wherein if said one of said one or more multimedia files has said attribute with said text equivalents of said multimedia content then the method further comprises the step of:
streaming said textual equivalents of said multimedia content to a web browser.

6. The method as recited in claim 1, wherein said one or more packets of data of said one of said one or more multimedia files is scanned for said one or more descriptor fields if said one of said one or more multimedia files does not have said attribute with said textual equivalents of said multimedia content.

7. The method as recited in claim 1 further comprising the step of:
streaming said textual equivalents of said multimedia content to a web browser.

8. The method as recited in claim 7 further comprising the step of:
outputting said textual equivalents of said multimedia content to a speech synthesizer.

9. The method as recited in claim 7 further comprising the step of:
outputting said textual equivalents of said multimedia content to a Braille display.

10. The method as recited in claim 5 further comprising the step of:
outputting said textual equivalents of said multimedia content to a speech synthesizer

11. The method as recited in claim 5 further comprising the step of:
outputting said textual equivalents of said multimedia content to a Braille display.

12. The method as recited in claim 1, wherein said multimedia content comprises graphic and audio information.

13. A computer program product having a computer readable medium having computer program logic recorded thereon for extracting textual equivalents of multimedia content stored in multimedia files, comprising:
programming operable for receiving a file specifying one or more multimedia files;
programming operable for scanning said file for a multimedia file tag;
programming operable for scanning one or more packets of data associated with one of said one or more multimedia files associated with said multimedia file tag for one or more descriptor fields, wherein said one or more descriptor fields comprise textual equivalents of a multimedia content of said one of said one or more multimedia files; and
programming operable for extracting said textual equivalents in said one or more descriptor fields.

14. The computer program product as recited in claim 13 further comprising:
programming operable for determining whether said one of said one or more multimedia files has an attribute with said textual equivalents of said multimedia content of said one of said one or more multimedia files.

15. The computer program product as recited in claim 14, wherein said attribute is an ALT attribute.

16. The computer program product as recited in claim 14, wherein said attribute is a LONGDESC attribute.

17. The computer program product as recited in claim 14, wherein if said one of said one or more multimedia files has said attribute with said text equivalents of said multimedia content then the computer program product further comprises:
programming operable for streaming said textual equivalents of said multimedia content to a web browser.

18. The computer program product as recited in claim 14, wherein said one or more packets of data of said one of said one or more multimedia files is scanned for said one or more descriptor fields if said one of said one or more multimedia files does not have said attribute with said textual equivalents of said multimedia content.

19. The computer program product as recited in claim 13 further comprising:
programming operable for streaming said textual equivalents of said multimedia content to a web browser.

20. The computer program product as recited in claim 19 further comprising:
programming operable for outputting said textual equivalents of said multimedia content to a speech synthesizer.

21. The computer program product as recited in claim 19 further comprising:
programming operable for outputting said textual equivalents of said multimedia content to a Braille display.

22. The computer program product as recited in claim 17 further comprising:
programming operable for outputting said textual equivalents of said multimedia content to a speech synthesizer.

23. The computer program product as recited in claim 17 further comprising:
programming operable for outputting said textual equivalents of said multimedia content to a Braille display.

24. The computer program product as recited in claim 13, wherein said multimedia content comprises graphic and audio information.

25. A system, comprising:
a web server configured to provide access to a web page;
a client coupled to said web server, wherein said client comprises:
a processor;
a memory unit operable for storing a computer program operable for extracting textual equivalents of multimedia content stored in multimedia files;
an input mechanism;
an output mechanism; and
a bus system coupling the processor to the memory unit, input mechanism, and output mechanism, wherein the computer program is operable for performing the following programming steps:
receiving a file specifying one or more multimedia files;
scanning said file for a multimedia file tag;
scanning one or more packets of data associated with one of said one or more multimedia files associated with said multimedia file tag for one or more descriptor field, wherein said one or more descriptor fields comprise textual equivalents of a multimedia content of said one of said one or more multimedia files; and
extracting said textual equivalents in said one or more descriptor fields.

26. The system as recited in claim 25, wherein the computer program is further operable to perform the following programming step:
determining whether said one of said one or more multimedia files has an attribute with said textual equivalents of said multimedia content of said one of said one or more multimedia files.

27. The system as recited in claim 26, wherein said attribute is an ALT attribute.

28. The system as recited in claim 26, wherein said attribute is a LONGDESC attribute.

29. The system as recited in claim 26, wherein if said one of said one or more multimedia files has said attribute with said text equivalents of said multimedia content then the computer program is further operable to perform the following programming step:
streaming said textual equivalents of said multimedia content to a web browser.

30. The system as recited in claim 25, wherein said one or more packets of data of said one of said one or more multimedia files is scanned for said one or more descriptor fields if said one of said one or more multimedia files does not have said attribute with said textual equivalents of said multimedia content.

31. The system as recited in claim 25, wherein the computer program is further operable to perform the following programming step:
streaming said textual equivalents of said multimedia content to a web browser.

32. The system as recited in claim 31, wherein the computer program is further operable to perform the following programming step:
outputting said textual equivalents of said multimedia content to a speech synthesizer.

33. The system as recited in claim 31, wherein the computer program is further operable to perform the following programming step:
outputting said textual equivalents of said multimedia content to a Braille display.

34. The system as recited in claim 29, wherein the computer program is further operable to perform the following programming step:
outputting said textual equivalents of said multimedia content to a speech synthesizer.

35. The system as recited in claim 29, wherein the computer program is further operable to perform the following programming step:
outputting said textual equivalents of said multimedia content to a Braille display.

36. The system as recited in claim 25, wherein said multimedia content comprises graphic and audio information.

37. A method for extracting textual equivalents of content stored in GIF files comprising the steps of:
receiving a file specifying one or more GIF files;
scanning said file for a GIF file tag;
scanning one or more packets of data associated with one of said one or more GIF files associated with said GIF file tag for one or more descriptor fields, wherein said one or more descriptor fields comprise textual equivalents of content of said one of said one or more GIF files; and
extracting said textual equivalents in said one or more descriptor fields.

38. The method as recited in claim 37 further comprising the step of:
determining whether said one of said one or more GIF files has an attribute with said textual equivalents of said content of said one of said one or more GIF files

39. The method as recited in claim 37, wherein said one or more packets of data of said one of said one or more GIF files is scanned for said one or more descriptor fields if said one of said one or more GIF files does not have said attribute with said textual equivalents of said content.

40. The method as recited in claim 37 further comprising the step of:
streaming said textual equivalents of said content to a web browser.

41. A method for extracting textual equivalents of content stored in JPEG files comprising the steps of:
receiving a file specifying one or more JPEG files;
scanning said file for a JPEG file tag;
scanning one or more packets of data associated with one of said one or more JPEG files associated with said JPEG file tag for one or more descriptor fields, wherein said one or more descriptor fields comprise textual equivalents of content of said one of said one or more JPEG files; and
extracting said textual equivalents in said one or more descriptor fields.

42. The method as recited in claim 41 further comprising the step of:
determining whether said one of said one or more JPEG files has an attribute with said textual equivalents of said content of said one of said one or more JPEG files.

43. The method as recited in claim 41, wherein said one or more packets of data of said one of said one or more JPEG files is scanned for said one or more descriptor fields if said one of said one or more JPEG files does not have said attribute with said textual equivalents of said content.

44. The method as recited in claim 41 further comprising the step of:
streaming said textual equivalents of said content to a web browser.
